(19) United States
(12) Patent Application Publication
(10) Pub. No.: US 2018/0146746 A1
(43) Pub. Date: May 31, 2018

(54) ARTICLE WITH SHAPE-MEMORY SECURING MEMBER

(71) Applicant: Jason Nikanpour, Saint-Lambert (CA)

(72) Inventor: Jason Nikanpour, Saint-Lambert (CA)

(21) Appl. No.: 15/693,466

(22) Filed: Aug. 31, 2017

Related U.S. Application Data
(60) Provisional application No. 62/381,791, filed on Aug. 31, 2016.

(51) Int. Cl. A43C 11/00; F03G 7/06; A43B 3/00; A43C 11/16; A45C 13/10

(52) U.S. Cl. CPC A43C 11/00; F03G 7/065; A43B 3/0005; A45C 3/06; A43C 11/16; A45C 13/10; A43B 3/0015

(57) ABSTRACT

An article that may be a wearable article includes a body having a first secured member and a second secured member, one securing member and a power modulator. The securing member is formed of a shape-memory material that is reactive to an energy source. A first end of the securing member engages the first secured member and a second end of the securing member engages the second secured member. The securing member is operable between a starting configuration and a deformed configuration to change relative positions of the first secured member and the second secured member. A power modulator is operable for imparting the securing member with the energy source in order to operate the securing member from the deformed configuration to the starting configuration. A method for using the article is also provided.

### TECHNICAL FIELD

The present disclosure generally relates to the field of fastening or securing systems, and more particularly, to an article having a shape-memory securing member.

### BACKGROUND

Typical fastening systems or securing systems known in the art for articles, such as wearable articles, include buttons, laces, shoe laces, belts and clasps and the like. It will be appreciated that these securing systems have been used for a long time with little change or improvement. Such securing systems also require manipulation by a human user. This manipulation requires a level of manual dexterity that is not possessed by everyone.

### SUMMARY

It would thus be highly desirable to be provided with a system or method that would at least partially address the disadvantages of the existing technologies.

The embodiments described herein provide in one aspect an article that includes an article body having a first secured member and a second secured member, at least one securing member formed of a shape-memory material reactive to an energy source, a first end of the securing member engaging the first secured member and a second end of the securing member engaging the second secured member, the securing member being operable between a starting configuration and a deformed configuration to change relative positions of the first secured member and the second secured member, and a power modulator for imparting the securing member with the energy source, in order to operate the securing member from the deformed configuration to the starting configuration.

The embodiments described herein provide in another aspect a method of using a wearable article having a securing member formed of a shape-memory material, a first end of the securing member engaging a first secured member of the article and a second end of the securing member engaging a second secured member of the article. The method includes causing the securing member to enter a deformed configuration from a starting configuration by applying a mechanical pulling force on the ends of the securing member, the mechanical pulling force causing the wearable article to loosen, wearing the wearable article onto a body part of a wearer and applying a non-mechanical energy to the securing member to cause the securing member to return to its starting configuration from its deformed configuration, thereby causing a tightening of the wearable article about the body part of the wearer.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 illustrates a schematic diagram of the operational modules of a physical article having a shape-memory securing system;

FIG. 2 illustrates a detailed schematic diagram of the operational modules of the shape-memory securing system according to one example embodiment;

FIG. 3 illustrates a power modulator circuit diagram of a shape-memory securing system according to one example embodiment;

FIG. 4 illustrates a perspective view of the physical article being a footwear article according to one example embodiment in which the securing member Is in a starting configuration; and

FIG. 5 illustrates a perspective view of the footwear article illustrated in FIG. 4 in which the securing member is in a deformed configuration.

### DETAILED DESCRIPTION

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein. The embodiments, geometrical configurations, materials mentioned and/or dimensions shown in the figures or described in the present description are embodiments only, given solely for exemplification purposes.

Moreover, although the embodiments of the article and corresponding parts thereof consist of certain geometrical configurations as explained and illustrated herein, not all of these components and geometries are essential and thus should not be taken in their restrictive sense. It is to be understood, as also apparent to a person skilled in the art, that other suitable components and cooperation thereinbetween, as well as other suitable geometrical configurations, may be used for the article, as will be briefly explained herein and as can be easily inferred herefrom by a person skilled in the art. Moreover, it will be appreciated that positional descriptions such as “above”, “below”, “left”, “right”, “forward”, “rear”, “upper”, “lower” and the like should, unless otherwise indicated, be taken in the context of the figures and should not be considered limiting.

The terms “coupled” or “coupling” as used herein can have several different meanings depending in the context in which these terms are used. For example, the terms coupled or coupling can have a mechanical or electrical connotation. For example, as used herein, the terms coupled or coupling can indicate that two elements or devices are directly connected to one another or connected to one another through one or more intermediate elements or devices via an electrical element, electrical signal or a mechanical element depending on the particular context.

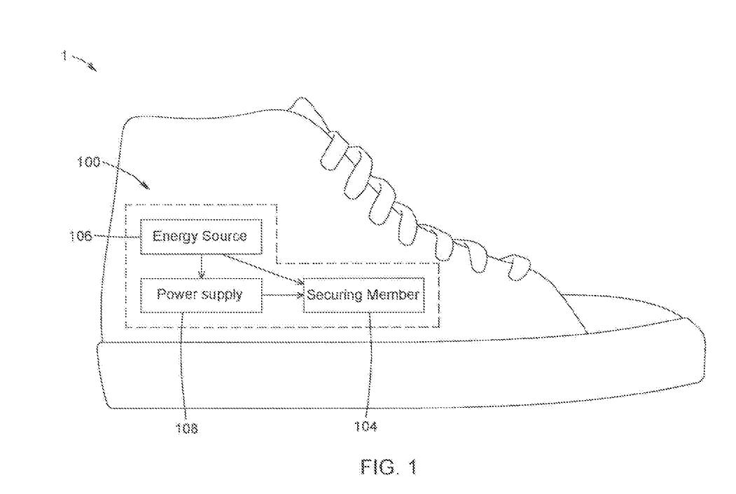

Referring to FIG. 1, therein illustrated is a schematic diagram of the operational modules of a physical article 1 having a shape-memory securing system 100 according to one example embodiment. The physical article 1 supports the shape-memory securing system 100 according to one example embodiment. The shape-memory securing system 100 includes at least one securing member 104, at least one energy source 106 and at least one power modulator 108.

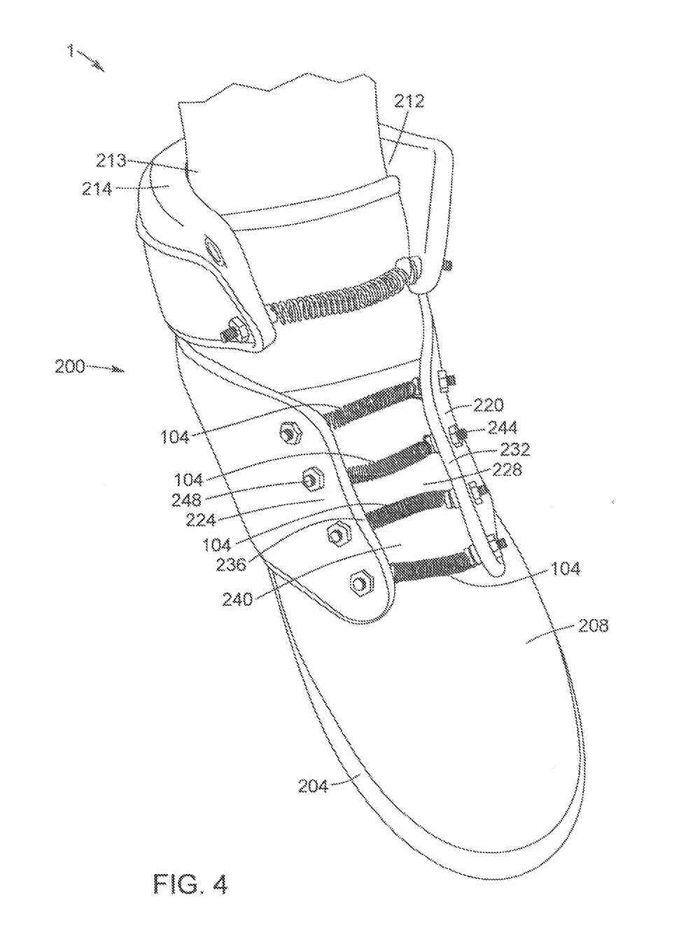

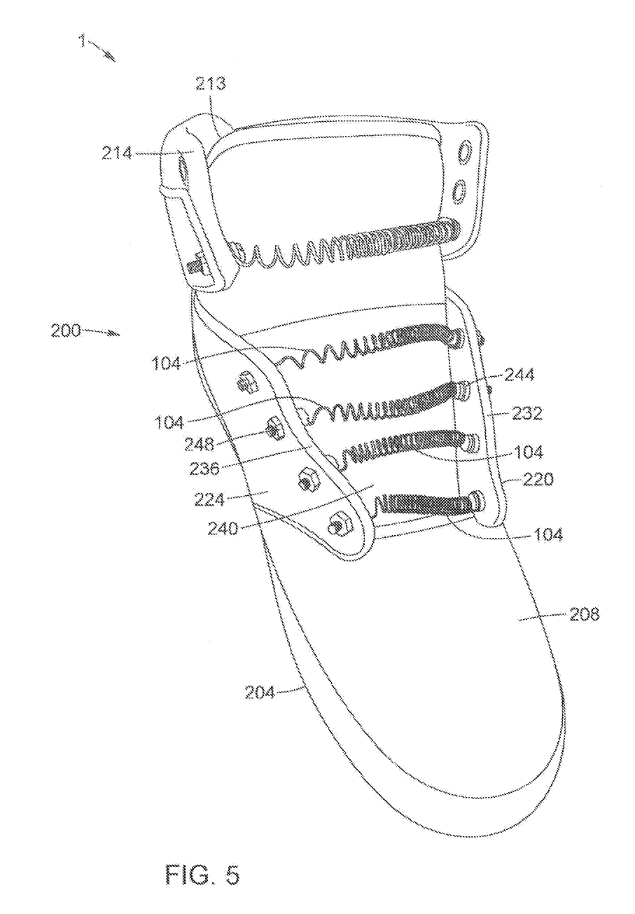

The physical article 1 herein refers to any article having a physical article body that further includes a first secured member and a second secured member. The first secured member engages a first end of the securing member 104 and a second secured member engages a second end of the securing member 104. Accordingly, the first secured member of the physical article 1 and the second secured member of the physical article 1 are coupled to one another via the at least one securing member 104. The relative positions of the first and second secured members are changed upon a deformation of the securing member 104 between its starting configuration (as exemplified in FIG. 4) and its deformed configuration (as exemplified in FIG. 5).

The at least one securing member 104 is formed of a shape-memory material. “Shape-memory material” herein refers to any material that when formed into a body has a starting configuration, which includes a first shape of the body. The body can be altered from its starting configuration to a deformed configuration by applying an external force. The body has a second shape while in the deformed configuration. The body can be returned from the deformed configuration to the starting configuration by application of a non-mechanical force. The external force for altering the starting configuration to the deformed configuration may be a mechanical force. The non-mechanical force applied to cause the shape-memory material to return to its starting configuration may be heating of the shape-memory material.

The shape-memory material may be a shape-memory alloy or shape-memory polymer. The shape-memory alloy may be a metal alloy such as Nickel-Titanium (Ni—Ti). A variety of other alloys having shape-memory properties may be used. The constituents of the shape-memory alloy may be adjusted to control the state at which the alloy returns from its deformed configuration to its starting configuration. Such shape-memory alloys may include one or more of:
Ag—Cd 44/49 at. % Cd
Au—Cd 46.5/50 at. % Cd
Cu—Al—Ni 14/14.5 wt % Al and 3/4.5 wt % Ni
Cu—Sn approx. 15 at % Sn
Cu—Zn 38.5/41.5 wt. % Zn
Gu—Zn—X (X=Si, Al, Sn)
Fe—Pt approx. 25 at. % Pt
Mn—Cu 5/35 at % Cu
Fe—Mn—Si
Co—Ni—Al
Co—Ni—Ga
Ni—Fe—Ga
Ti—Nb
Ni—Ti approx. 55-60 wt. % Ni
Ni—Ti—Hf
Ni—Ti—Pd
Ni—Mn—Ga
Ni—Ti—Cu—Co

Due to the engagement of the at least one securing member 104 with the first and second secured members of the physical article 1, the change in the shape of the at least one securing member 104 between its starting configuration and its deformed configuration and vice-versa causes the positions of the first and second secured members relative to one another to be modified. For example, a distance between the first and second secured members of the physical article 1 is smaller upon the securing member 104 being in its starting configuration versus upon the securing member 104 being in its deformed configuration.

The at least one power modulator 108 is operable to cause the securing member 104 to enter its starting configuration from its deformed configuration by imparting the securing member 104 with energy from the energy source 106. The energy source may cause heating of the at least one securing member 104 such that the temperature of the securing member 104 rises, which causes it to return its starting configuration from its deformed configuration due to its shape-memory properties.

The energy source 106 may be an electric energy source that is operable to provide an electric current to the securing member 104. The electric current flows through the securing member 104, which causes the securing member 104 to be heated by ohmic healing.

The power modulator 108 may be implemented using one or more electrical circuit elements. At least some of the circuit elements may be further implemented on one or more printed circuit board. In some example embodiments, semiconductor elements may be used, such as for implementing a microcontroller (ex: microprocessor) of the power modulator 108.

According to one example embodiment, the power modulator 108 may be implemented as a switch that opens and closes a connection between the power source 106 and the securing member 104. A user can operate the switch of the power modulator 108 to selectively cause power to be directly supplied to the securing member 104.

According to another example embodiment, the power modulator 108 is operable to modulate power delivered from the power source, thereby controlling the amount of electric current that flows through the securing member 104. Accordingly, the power modulator 108 may be used to control the amount of heating that is applied to the at least one securing member 104. For example, the modulator may be implemented partly or wholly using semiconductor elements.

The power modulator 108 may be configured to deliver electrical energy so that a desired amount of heat is applied to the securing member 104. For example, the power modulator 108 may control the average electric current flowing through the securing member 104. The power modulator 108 may also control the instantaneous electric current flowing through the securing member 104. The power modulator 108 may further control the duration at which electric current is delivered to the securing member 104. It will be appreciated that controlling the flow of electric current to the securing member 104 further controls the average amount of heat, the instantaneous amount of heat and/or the total amount of heat applied to the securing member 104.

The amount of electric current, and thereby amount of heat, delivered to the at least one securing member 104 may be pre-configured or adjusted according to properties of the securing member 104, a desired performance of the physical article 1 and to a desired starting configuration of the at least one securing member 104. For example, the instantaneous amount and/or total amount of electric flow, or heating, delivered to the securing member 104 may be controlled to be below a critical temperature of the securing member 104. The critical temperature refers to the temperature threshold at which the securing member 104 may be heated without experiencing failure due to overheating. The average amount of heat per unit of time may be controlled depending on the desired speed at which the securing member 104 returns to its starting configuration from its deformed configuration. Applying more electric current/heat can cause the securing member 104 to be actuated more quickly from its deformed configuration to its starting configuration than a lower electric current/amount of heat. The amount of electric current applied may further depend on a resistance of the at least one securing member 104.

According to one example embodiment, the modulator of the power modulator 108 is a pulse-width modulator. The pulse-width modulator is coupled to electric energy source and controls the flow of electric current from the energy source 106 into the securing member 104. The instantaneous amount of electric current flowing into the securing member 104 may be controlled by appropriately selecting a voltage of the energy source based on the resistance of the at least one securing member 104 receiving current therefrom. The average amount of electric current per unit of time may be controlled according to a selected duty cycle of the pulse-width modulator. The total amount of electric current may be controlled by varying the amount of time the pulse-width modulator emits pulsed width wave any time that it is actuated.

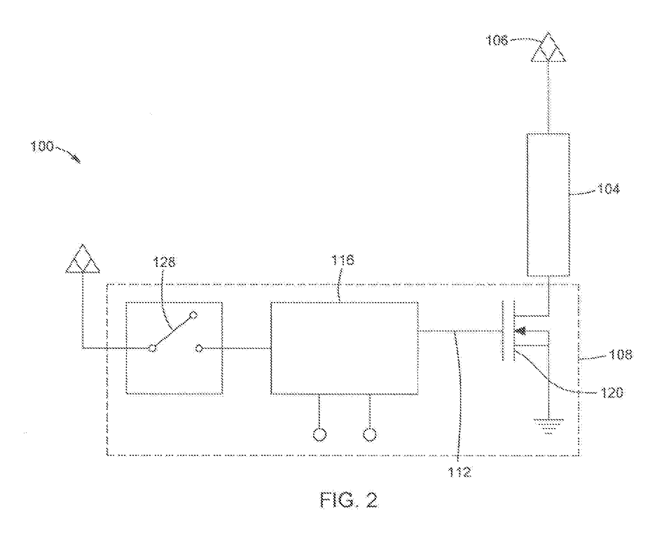

Referring now to FIG. 2, therein illustrated is a detailed schematic diagram of the operational modules of the shape-memory securing system 100 according to one example embodiment. As illustrated, an output signal line 112 of a timer 116 of a pulse-width modulator is connected to a gate terminal of a MOSFET 120. The MOSFET 120 acts as a switching device that selectively allows current to flow from the energy source 106 to the securing member 104. A first input of the timer 116 may be connected to a switch 128, which allows for selectively operating the power modulator 108 to cause the securing member to enter its starting configuration. The switch 128 may be controlled by a user and, upon closing of the switch 128, the power modulator 108 is operated to emit a pulsed width wave to the MOSFET 120 according to a duty cycle (ex: the duty cycle is adjusted by a potentiometer 130), and operating time configured for the power modulator 108. One or more second inputs of the timer 116 may be connected to additional one or more input devices (ex: physical switch, sliders, knobs) for controlling the duty cycle and/or operating time of the power modulator 108, which in turns controls the average electric current provided to the securing member 104 per unit time and/or the total amount of electric current applied to the securing member 104.

According to one example embodiment, the power modulator 108 may be digitally configured, such as, using a wirelessly connected device, such as a smartphone.

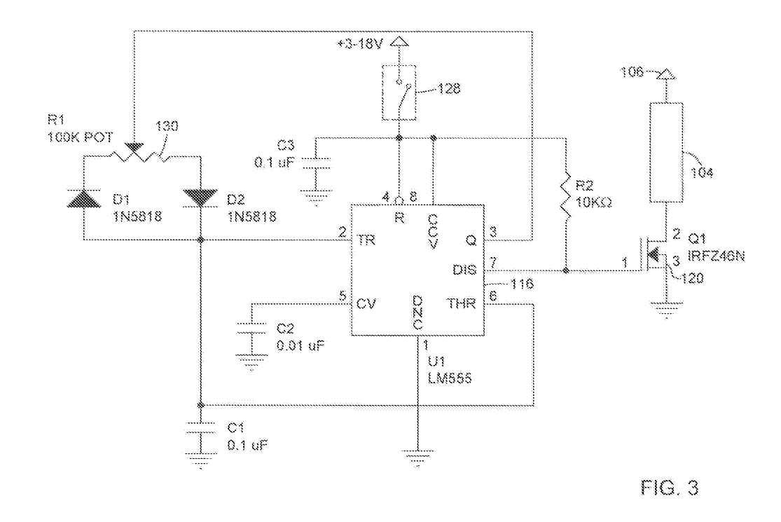

Referring now to FIG. 3, therein illustrated is a circuit diagram of the shape memory securing system 100 according to one example embodiment. The timer 116 of the power modulator 108 is connected to the gate terminal of the MOSFET 120, which causes current to flow through the securing member 104 from the electric energy source 106. A “R” port of the timer 116 is coupled to a voltage source via a switch 128 for selectively operating the power modulator 108. A potentiometer 130 is connected between the “TR” port and “Q” port of the timer 116. Varying the resistance of the potentiometer 130 causes the duty cycle of the signal outputted from the power modulator 108 to be varied.

As described elsewhere herein, the relative positions of the first and second secured members are changed upon a deformation of the securing member 104 between its starting configuration and its deformed configuration. By coupling the first and second secured members using the securing member 104 having the shape-memory property, the relative positions of the first and second secured members can be changed by controlling the power modulator 108 to impart the energy source 106 to the securing member 104.

In one example embodiment, the first and second secured members are positioned opposite one another to define a gap therebetween. The securing member 104 is coupled to the first and second secured members such that the gap is narrowed upon the securing member 104 being operated from its deformed configuration to its starting configuration.

Additionally or alternatively, the article body defines a cavity and a change in the relative positions of the first and second secured members change a volume of the cavity. More particularly, the securing member 104 is coupled to the first and second secured members such that the volume of the cavity is decreased upon the securing member 104 being operated from its deformed configuration to its starting configuration.

In various example embodiments, the securing member 104 has a contracted shape when in the starting configuration and has an extended shape when in the deformed configuration. Accordingly, operation of the securing member 104 from the starting configuration to the deformed configuration may cause the first and second secured members to be moved away from one another. Operation of the securing member 104 from the deformed configuration to the starting configuration may cause the first and second secured members to be pulled towards one another.

According to various example embodiments, the physical article 1 is a wearable article. Wearable article herein refers to an article that may be worn or carried by a wearer. The wearer may be a human, animal or robot.

In one example, the wearable article may be an article that may be worn by the wearer and which receives at least one body part of the user. In a first example, the wearable article may be a footwear article that receives a foot of the wearer user. In a second example, the wearable article may be a clothing article. When worn by a wearer, at least one body part of the wearer projects through an opening defined by the clothing article. For example, the wearable article may be an accessory article, such as a jewelry, hat, belt, watch, bracelet, hair accessory, etc. When worn by the wearer, the at least one part of the wearer may also project through an opening defined by the accessory article.

In another example, the wearable article may be carried by the wearer. For example, the wearable article may be a bag article, such as a handbag, wallet, backpack or luggage. The first and second members correspond to parts of the carried article that define an opening for accessing an inner cavity in which items are being carried. In the starting configuration, the at least one securing member closes first and second members so as to restrict access to the inner cavity through the opening. In the deformed configuration, the first and second members are position away from one another so as to provide access to the inner cavity through the opening.

As described elsewhere herein, the first and second ends of the securing member engage the first and second secured members of an article body of the wearable article respectively. In some example embodiments, the first and second secured members may be positioned opposite of one another and define a gap therebetween. The securing member being operated from its deformed configuration to its starting configuration causes the gap to be narrowed. In the examples of a footwear article, clothing article or accessory article, the first and second secured members of the wearable article operate to secure the article body about a body part of a wearer who is wearing the wearable article.

Additionally or alternatively, the article body defines a cavity. The operating of the securing member from its deformed configuration to its starting configuration reuses the relative positions of the first and second secured members to be modified, which further causes the volume of the cavity to be decreased compared to when the securing member is in its deformed configuration. In the examples of a footwear article, clothing article or accessory article, a body part of the wearer may be received within the cavity and the decrease in volume causes the article body to be tightened about the body part, such as to form a snug fit about the body part.

According to various example embodiments, the power modulator 108 of the wearable article 1 is embedded within article body. The power modulator 108 being embedded herein refers to the power modulator 108 being attached to the article body such that the power modulator 108 and the article body form a unitary contiguous body. In some example embodiments, modules of the power modulator 108 are embedded within the article body such that they are concealed from view.

Referring now to FIG. 4, therein illustrated is a perspective view of a physical article 1 according to one example embodiment. As illustrated, the physical article 1 is a wearable article. More specifically, the wearable article 1 illustrated in FIG. 4 is a footwear article 1. While the illustrated footwear article is a boot, in other examples, the footwear article may be a shoe, a slipper, a sporting equipment (ex: skates, ski boot), etc. The footwear article 1 has an article body 200 corresponding to the parts of a typical footwear article. As is typical for a footwear article, the body 200 of the example footwear article 1 includes a sole portion 204 and an upper portion 208 that define together an inner cavity 212 of the body 200. When worn, the foot of the human wearer is inserted through an opening 213 defined by the top edge 214 of the upper portion 208 and received within the inner cavity 212 and further supported over the insole of the sole portion 204.

A first lateral panel member 220 of the upper portion 208 of the footwear article 1 corresponds to a first secured member of the footwear article 1. A second lateral panel member 224 of the upper portion 208 of the footwear article 1 corresponds to a second secured member of the footwear article 1. The first and second lateral panels 220 and 224 each partially overlap a respective edge of the tongue member 228 of the footwear article 1. In the illustrated example, the first lateral panel member 230 is a left lateral panel and the second lateral panel member 224 is a right lateral panel. The first lateral panel member 220 is positioned oppositely of the second lateral panel member 224. A lengthwise edge 232 of the first lateral panel member 220 is spaced apart from a lengthwise edge 230 of the second lateral panel 224. The first and second lateral panel members 220, 224 define therebetween a gap 240.

The at least one securing member 104 is positioned between the first lateral panel member 220 and the second lateral panel member 224 and couple together the two lateral panel members 220, 224. A first end 244 of the securing member 104 engages the first lateral panel member 220 and a second end 248 of the securing member 104 engages the second lateral panel member 224. In the illustrated example, a plurality of securing members 104 are provided, each securing member having a first end engaging the first lateral panel member 224 and a second end engaging the second lateral panel member 228. A first of the securing members 104 engages a forward portion (ex: the portion closer to the front portion of the upper portion 208) of the first and second lateral panel members 220, 224 and a second of the securing members 104 engages a rearward portion (ex: the portion closer to the top edge 214 of the upper portion 208) of the first and second lateral panes members 220, 224.

Where the energy source for applying the non-mechanical force to the securing member 104 provides an electric current, the plurality of securing members 104 may be connected in series, whereby the same amount of current flows through each of the securing members 104.

Alternatively, at least two of the securing members 104 may be connected in parallel. The at least two securing members 104 may have the same resistance (and therefore receive the same amount of current) or have different resistance.

In yet another example embodiment, more than two securing members 104 may be connected in a combination of series and parallel connections.

In other examples, more than one electrical energy source may be provided so that at least two securing members 104 receive electrical energy from different energy sources.

FIG. 4 illustrates the example footwear article 1 in which the at least one securing member 104 is in its starting configuration. In the illustrated example, the securing member 104 is formed of one or more coiled members extending between the first and second lateral panel members 220, 224. It will be appreciated that in the starting configuration, the securing member 104 is in a substantially contracted state. The at least one securing member 104 may be elastic, whereby the securing member 104 may be slightly stretched and return to its starting configuration and contracted state. In other examples, the securing member 104 may be a strip member, a thin fin coating, a strut or a wire).

Referring now to FIG. 5, therein illustrated is a perspective view of the footwear article 1 illustrated in FIG. 4, in which the at least one securing member 104 has been actuated to its deformed configuration. In the illustrated deformed configuration, the first and second lateral panel members 220 have been displaced away from one another such that the gap 240 defined therebetween has become wider. The body 200 of the footwear article 1 has been generally expanded and the volume of the inner cavity 212 has been increased. It will be appreciated that the deformed configuration of the securing member 104 causes the body 200 to assume a shape that allows easy insertion and removal of the wearer's foot to and from the inner cavity 212 of the footwear article 1.

Upon entering the deformed configuration, the securing member 104 has an extended shape and its length is increased versus its length when in the starting configuration. The securing member 104 may be actuated to its deformed configuration from its starting configuration from an application of a mechanical force on ends 244 and 248 of the securing member 104. For example, this mechanical force may be applied by pulling the first and second lateral panels 220 and 224 away from one another. The securing members 104 maintain their deformed configuration until the non-mechanical force is applied to cause the securing member 104 to be operated back to its starting configuration.

For example, and as illustrated, the coiled securing members 104 have been stretched away from its compressed state. Where the coiled securing members 104 are elastic, the mechanical force applied to operate the securing members 104 to the deformed configuration causes the coiled securing members 104 to be stretched past its elastic limit such that the coiled securing member does not return to its starting configuration due to elasticity.

Upon applying the non-mechanical force, such as heating, to the at least one securing member 104, the at least one securing member 104 is operated from its deformed configuration to its starting configuration, as illustrated, for example in FIG. 4. Due to the engagement of the ends 244 and 240 of the securing member 104 with the first and second lateral panel members 220, 224 respectively, the operation of the securing member 104 to its starting configuration causes the first and second lateral panel members 220, 224 to be displaced towards one another. This displacement narrows the gap 240 defined therebetween. The displacement of the lateral panels 220, 224 further caused the body 200 to tighten and the volume of the inner cavity 212 to be decreased. It will be appreciated that the starting configuration of the securing member 104 causes the body 200 to assume a shape that forms a tight and snug fit about the wearer's foot. This snug fit restricts accidental removal of the footwear article 1 while it is being worn by the wearer.

It will be appreciated that in the illustrated example footwear 1, the securing members 104 are located in place of where shoelaces of a footwear article would typically be located. It will be further appreciated that whereas shoelaces are used in a typical footwear article for tightening the footwear article about a wearer's foot, the function of tightening the footwear article 1 according to example embodiments described herein are provided by the at least one securing members 104. The deformed configuration of the at least one securing member 104 corresponds to the shoelaces being unknotted so as to allow insertion and removal of the wearer's foot. The starting configuration of the at least one securing member 104 corresponds to the shoelaces being knotted so as retain the footwear article 1 about the wearer's foot.

As described elsewhere herein, the energy source 106 and the power modulator 108 provide the non-mechanical force that causes the securing member 104 to enter its starting state from its deformed state. According to various example embodiments, the energy source 106 and modules of the power modulator 108 may be physically embedded within the footwear article 1.

Where the energy source 106 provides an electric current, the energy source 106 may be electrically coupled to the at least one securing member 104 via one or more electrical path that may also be embedded within the wearable article 1.

The energy source 106 may be provided in the form of a battery, capacitor, super capacitor, solar cells, piezo electric cells or nuclear cells. A micro or nano battery may be embedded in the heel or other parts of the footwear article 1, within the fabric forming the upper, or as part of the securing member 104.

In some example embodiments, the energy source 106 may be rechargeable. The recharging may be carried out by connecting the energy source 106 to an external power source, such as an AC/DC main power, via an inlet that is also embedded within the wearable article 1.

Alternatively, the recharging may be provided by a piezo-electric generator embedded in the wearable article 1 and that harvests mechanical energy from movement of the wearable article 1.

Alternatively, the recharging may be provided by photovoltaic solar cells embedded in the wearable article 1 and that harvests energy from a light source.

The recharging may also be provided by a wireless charging, such as wireless inductive charging. For example, a charged device may be embedded within the wearable article 1 and electrically coupled to the energy source 106. The charged device begins recharging upon being placed in proximity of a wireless charging device that is external to the wearable article 1. In the example of a footwear article, the charged device may be embedded within the sole of the footwear article 1 and the charging device may be embedded in a member disposed over a floor, such as a floor mat. Accordingly, recharging occurs when the footwear article 1 is placed over the charging device of the floor mat.

The switch 128 of the power modulator 108 may also be embedded within the wearable article 1. The switch 128 may be located on a surface of the wearable article 1 at a location that is easy to reach for the wearer. The switch 128 may be provided in the form of a switch that can be manually operated by the wearer, such as a button switch, toggle switch, or touch-sensitive (ex: capacitive) switch.

The switch 128 may also be provided as a pressure sensitive switch. The switch may be placed at location where the wearer would normally apply pressure when wearing the wearable article 1. For example, the pressure sensitive switch may be placed within the insole of the footwear article 1 to detect pressure applied by the foot of the wearer received within the inner cavity 212.

According to various example embodiments, switch 128 may be a wireless receiver that receives a wireless signal from an external actuation signal. Upon receiving the external actuation signal, the power modulator 108 is controlled to apply the non-mechanical force to cause the securing member 104 to enter its starting configuration from its deformed configuration. The external actuation signal may be transmitted from a portable user device running suitable software, such as a user using an app on a smartphone or tablet.

One or more input devices may be provided and embedded within the wearable article for allowing the wearer to configure the power modulator 108, and more specifically the modulator 116 of the power modulator 108. The wearer may use one or more input devices (ex: physical switch, sliders, knobs) to adjust how quickly the at least one securing member 104 is operated from its deformed configuration to its starting configuration, which corresponds to how quickly the body 200 is tightened about the body part of the wearer. The wearer may also adjust the tightness of the body 200 about the body part.

According to one example embodiment, the power modulator 108 may further include a tension sensor for sensing the tightness of the first and second secured members about the body part of the wearer. The tension sensor may control the power modulator 108 to stop causing operating of the at least one securing member to its starting configuration upon the sensed tension exceeding a predetermined tension threshold. The tension threshold may correspond to a desired tightness of the body article 200 about the wearer's body part.

It will be appreciated that in the case of a footwear article 1, the shape memory securing system 100 provided within the footwear article 1 provides ease of use to the wearer. In particular, whereas the wearer previously needed to maintain a bent over position for an extended amount of time in order to tie and untie shoelaces of the footwear article 1 when putting on or removing the footwear article 1, the providing of the shape-memory securing system 100 substantially reduces the amount of time that the bent over position needs to maintained. The action of untying the shoelaces is replaced by a simpler action of pulling the first and second lateral panels 220, 224 away from one another to loosen the footwear article 1 about the foot, which causes the at least one securing member 104 to be operated to its deformed configuration from its starting configuration. The action of tying the shoelace is replaced by the simpler action of operating the switch 128 to cause the power modulator 108 to apply the non-mechanical force that further causes the shape-memory securing member 104 to be operated from its deformed configuration to its starting configuration.

According to various example embodiments, the wearable article 1 is a clothing article and the first and second secured members thereof operate to secure the article body about a body part of the human wearer. The clothing article may be an upperwear article, such as a shirt or jacket. The first and second secured members may be left and right breast panels of the upperwear article and the securing member 104 acts to tighten the left and right breast panels about the torso of the wearer. Alternatively, or additionally, the first and second secured members may be left and right collars of the upper wear article and the securing member 104 acts to tighten the collar about the neck of the wearer. Alternatively, or additionally, the first and second secured members may be cuff panels of the upper wear article and the securing member 104 acts to tighten the cuff about an arm or wrist of the wearer.

According to a method of use of the wearable article 1 having a shape-memory system 100, a mechanical force is applied on the ends of the at least one securing member 104 or the first and second secured members engaged thereto so as to cause the securing member 104 to be operated to its deformed configuration. This causes the body article 200 of the wearable article 1 to loosen. As described elsewhere herein, this may cause the gap between the first and second secured members to be widened and/or the cavity defined by the article body to be increased. The article body 200 of the wearable article 1 is worn onto a body part of the wearer. For example, the body part may be inserted through an opening defined by the article body 200 or into a cavity defined by the article body 200. The switch 128 of the power modulator 108 is then actuated to cause the imparting of the energy source to cause the securing member 104 to be operated from its deformed configuration to its starting configuration, thereby tightening the article body 200 about the body part of the user.

According to various example embodiments wherein an electrical energy source 106 is provided within the system 100 for applying a current to the securing member 104, other electrically powered devices may also be included within the wearable article 1. For example, one or more visual feedback devices may be included on a surface of the wearable article 1. The visual feedback device may be a light emitting device, such as an LED. The visual feedback device may be a display device, such as an LCD, LED, OLED, AMOLED, Plasma, QDLED, flexible display or E-paper. Other electrically powered sensing device may be embedded, such as a step-counter, battery charge monitor or display settings. A communication device, such as Bluetooth device, may be used to transmit the sensed conditions to an external device, such as a smartphone or tablet.

While various example embodiments have been described herein in the context of the physical article 1 being a wearable article 1, it will be understood that in other examples the physical article 1 may be any article in which the physical article 1 has a first and second secured member that are coupled together by a shape-memory securing member 104 whose position relative to one another are changed from the securing member 104 being operated between its starting configuration and its deformed configuration. For example, the securing member 104 may act as a locking mechanism. For example, the securing member 104 may act as an automatic hinge for a door wherein the first secured member is the door member and the second secured member is the door frame.

According to various example embodiments, the shape-memory material may be a two-way material wherein when formed into a body, it can be altered from its starting configuration to a deformed configuration by application of a first non-mechanical force and be returned to its starting configuration by application of a second non-mechanical force. The first non-mechanical force and the second non-mechanical force can both be heating of the shape-memory material. Furthermore, the at least one power modulator 108 is operable to cause the securing member 104 to enter its deformed configuration from its starting configuration and return to the starting configuration from the deformed configuration. Accordingly, the power modulator 108 is operable to cause the securing member 104 to change configuration such that the gap between first and second secured members is selectively increased and decreased. Additionally or alternatively, the power modulator 108 is operable to cause the securing member 104 to change configuration such that the volume of the cavity defined by the article body is selectively increased and decreased.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative and non-limiting and it will be understood by persons skilled in the art that other variants and modifications may be made without departing from the scope of the invention as defined in the claims appended hereto.

1. An article comprising:
an article body having a first secured member and a second secured member;
at least one securing member formed of a shape-memory material reactive to an energy source, a first end of the securing member engaging the first secured member and a second end of the securing member engaging the second secured member, the securing member being operable between a starting configuration and a deformed configuration to change relative positions of the first secured member and the second secured member; and
a power modulator for imparting the securing member with the energy source, in order to operate the securing member from the deformed configuration to the starting configuration.

2. The article of claim 1, wherein the starting configuration corresponds to a contracted shaped of the securing member and the deformed configuration corresponds to an extended shape of the securing member.

3. The article claims 1 or 2, wherein the first secured member and the second secured member are positioned opposite one another and define a gap therebetween; and
wherein the gap is narrower upon the securing member being in the starting configuration than upon the securing member being in the deformed configuration.

4. The article of any one of 1 to 3, wherein the article body defines a cavity, the volume of the cavity being decreased upon the securing member being in the starting configuration than the volume upon the securing member being in the deformed configuration.

5. The article of any one of claims 1 to 4, wherein the power modulator is operatively connected to the energy source for heating the securing member, the heating causing the securing member to enter its starting configuration from its deformed configuration.

6. The article of claim 5, wherein the energy source provides an electric current to the securing member and wherein the securing member is heated by ohmic heating from flow of the electric current therethrough.

7. The article of claim 6, wherein the power modulator further comprises a modulator for controlling the flow of the electric current into the securing member.

8. The article of claim 7, wherein the modulator is a pulse-width modulator.

9. The device of any one of claims 1 to 8, wherein the power modulator further comprises a switch module for selectively operating the power modulator to cause the securing member to enter the starting configuration.

10. The article of any one of claims 1 to 9, wherein the energy source includes an energy storage device embedded in the article body.

11. The article of any one of claims 1 to 10, wherein the energy storage device is chosen from one of a battery, capacitor and super capacitor.

12. The article of claim 11, wherein the energy storage device is rechargeable.

13. The article of any one of claims 1 to 12, wherein the securing member enters its deformed configuration by application of a mechanical force causing the secured members to be pulled away from one another.

14. The article of any claims 1 to 13, wherein the article body is wearable over a body part of the wearer.

15. The article of claim 14, wherein the article body forms a snug fit about the body part upon the securing member being in the starting configuration.

16. The article of claims 14 to 15, wherein the article is a footwear article and wherein the first secured member corresponds to a first lateral panel of an upper of the article body of the footwear article and the second secured member corresponds to a second lateral panel of the upper of the article body of the footwear article.

17. The article of claim 16, wherein the at least one securing member is located in place off shoelaces of the article body.

18. The article of claims 16 or 17, wherein the at least one securing member comprises a plurality of securing members, a first of the plurality of securing members being located in a forward portion of the first and second secured members and a second of the plurality of securing members being located in a rearward portion of the first and second secured members, the first securing member having a shorter length upon being in its starting configuration than the second securing member upon being in its starting configuration.

19. The article of any one of claims 16 to 18, further comprising a tension sensor for sensing a tightness of the first and second secured members upon a foot of the wearer, the tension sensor controlling the power modulator to stop causing operating of the at least one securing member to its starting configuration upon a sensed tension exceeding a predetermined tension threshold.

20. The wearable device of any one of claims 1 to 13, wherein the wearable article is a clothing article and wherein the first secured member and the second secured member further an opening of the article body of the clothing article, a body part of the wearer projecting through the opening upon wearing the clothing article.

21. The wearable device of any one of claims 1 to 13, wherein the wearable article is a wearable accessory article.

22. The wearable device of any one of claim 1 to 13, wherein the wearable accessory article is a bag, the article body defining an inner cavity, the first secured member and the second secured member defining an opening for accessing the inner cavity.

23. The method of any one of claims 1 to 22, wherein the power modulator is further operable to impart the securing member with the energy source in order to operate the securing member from the starting configuration to the deformed configuration.

24. A method of using a wearable article having a securing member formed of a shape-memory material, a first end of the securing member engaging a first secured member of the article and a second end of the securing member engaging a second secured member of the article, the method comprising:
causing the securing member to enter a deformed configuration from a starting configuration by applying a mechanical pulling force on the ends of the securing member, the mechanical pulling force causing the wearable article to loosen;
wearing the wearable article onto a body part of a wearer;
applying a non-mechanical energy to the securing member to cause the securing member to return to its starting configuration from its deformed configuration, thereby causing a tightening of the wearable article about the body part of the wearer.

25. The method of claim 24, further comprising applying a non-mechanical energy to the securing member to cause the securing member to enter its deformed configuration from its starting configuration, thereby causing a loosening of the wearable article about the body part of the wearer.
